(19) United States
(12) Patent Application Publication
(10) Pub. No.: US 2001/0042248 A1
(43) Pub. Date: Nov. 15, 2001

(54) Receiver, viewing information recording method, viewing information processor, service contents decision method, information acquisition apparatus, information acquisition method, transmitter/receiver system, and recording media

(76) Inventors: Keisei Yamamuro, Osaka (JP); Yuki Kusumi, Nara (JP); Tatsuya Shimoji, Osaka (JP); Yasuyuki Sonoda, Kyoto (JP); Rikiya Masuda, Osaka (JP); Shigeshi Arai, Osaka (JP); Hidekazu Tanigawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/821,049

(22) Filed: Mar. 30, 2001

(30) Foreign Application Priority Data
Mar. 30, 2000 (JP) 2000-095386
Mar. 31, 2000 (JP) 2000-096201

(51) Int. Cl. H04N 7/16; H04H 9/00

(52) U.S. Cl. 725/14; 725/2

(57) ABSTRACT

A receiver comprises a program acceptor for accepting program contents, and a program identifier to identify the program contents; a display unit for displaying the program contents; an input acceptor for accepting an input from a user; a display attribute acquisition unit for obtaining a display attribute by which the program contents are displayed; and a viewing information recorder for recording viewing information including the program identifier and the display attribute, on a removable recording medium, when the input acceptor accepts a predetermined user input. Therefore, the receiver can record the viewing information indicating that the user has viewed a specific program, on the removable recording medium.

### FIELD OF THE INVENTION

The present invention relates to a receiver that can record viewing information indicating that a user has viewed a specific program, on a removable recording medium, a viewing information recording method, a viewing information processor that can provide the user with service contents on the basis of the information recorded on the recording medium, and a service contents decision method. Further, the invention relates to an information acquisition apparatus for obtaining information from an information server on the basis of acquisition information recorded on a removable recording medium, and a transmitter/receiver system.

### BACKGROUND OF THE INVENTION

Conventionally, various services have been distributed using various advertising media. For example, in the case of a fast-food shop, discount coupons of a hamburger or the like are distributed on the street together with handbills of a new product. When a person who received the discount coupon goes to the fast-food shop with the discount coupon, he/she can receive a service such as a discount of the price of a hamburger or the like.

In recent years, it is also possible to receive the same service as described above by accessing a homepage of the fast-food shop through the Internet, printing out a discount coupon shown on the homepage, and going to the fast-food shop with the discount coupon.

Furthermore, there is a service of recording information on a removable recording medium. To be specific, when a user drops a predetermined amount of money into a machine placed in a convenience store or the like, information selected by the user, such as music or the like, is recorded on a removable recording medium. By utilizing this service, the possessor of the removable recording medium can easily get desired information.

However, you can get the above-described service at the fast-food shop only when you actually received the discount coupon on the street or when you accessed the homepage of the fast-food shop through the Internet and printed out the discount coupon.

Accordingly, even if you have viewed a CM of the fast-food shop on TV, you cannot receive the service as described above because it is difficult to prove that you have viewed the CM on TV.

On the other hand, the possessor of the removable recording medium cannot obtain information such as music other than those stored in the machine placed in the convenience store and, moreover, the possessor cannot obtain the information without playing the charge.

### SUMMARY OF THE INVENTION

The present invention is made to solve the above-described problems and has for its object to provide a receiver which can record viewing information indicating that a user has viewed a program or the like broadcast on television, on a removable recording medium, and a method for recording the viewing information and, further, a viewing information processor by which the user can receive a service according to the viewing information recorded on the recording medium, a method for deciding the contents of the service, and a transmitter/receiver system.

Furthermore, it is another object of the present invention to provide an information acquisition apparatus and an information acquisition method, by which the user can obtain information from an information server on the basis of acquisition information recorded on a removable recording medium, and a recording medium on which acquisition information is recorded.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided a receiver comprising: a program acceptor for accepting program contents, and program information having a program identifier to identify program contents; a display unit for displaying the program contents; and a viewing information recorder for recording viewing information having the program identifier to identify the program contents on a removable recording medium, when the program contents are displayed on the display unit.

According to a second aspect of the present invention, the receiver of the first aspect further comprises a display attribute acquisition unit for obtaining a display attribute that is an attribute by which the program contents are displayed; and the viewing information has the display attribute and the program identifier.

According to a third aspect of the present invention, in the receiver of the second aspect, the display attribute is the position where the program contents are displayed.

According to a fourth aspect of the present invention, in the receiver of the first aspect, the viewing information further includes the number of viewing times, which is the number of times a user has viewed the program contents.

According to a fifth aspect of the present invention, the receiver of the first aspect further comprises an input acceptor for accepting a user input; and when the program contents are displayed on the display unit on the basis of the user input accepted by the input acceptor, the viewing information recorder records the viewing information on the removable recording medium.

According to a sixth aspect of the present invention, in the receiver of the fifth aspect, when the input acceptor accepts the user input for a predetermined period of time, the viewing information recorder records the viewing information on the removable recording medium.

According to a seventh aspect of the present invention, in the receiver of the fifth aspect, the input acceptor accepts an input of information related to the program; and when the input acceptor accepts the related information, the viewing information recorder records the viewing information on the removable recording medium.

According to an eighth aspect of the present invention, there is provided a viewing information recording method comprising: a program accepting step of accepting program contents, and program information having a program identifier to identify program contents; a display step of displaying the program contents; and a viewing information recording step of recording viewing information having the program identifier to identify the program contents on a removable recording medium, when the program contents are displayed on the display unit.

According to a ninth aspect of the present invention, the viewing information recording method of the eighth aspect further comprises a display attribute acquisition step of obtaining a display attribute that is an attribute by which the program contents are displayed; and the viewing information has the display attribute and the program identifier.

According to a tenth aspect of the present invention, in the viewing information recording method of the ninth aspect, the display attribute is the position where the program contents are displayed.

According to an eleventh aspect of the present invention, in the viewing information recording method of the eighth aspect, the viewing information further includes the number of viewing times, which is the number of times a user has viewed the program contents.

According to a twelfth aspect of the present invention, the viewing information recording method of the eighth aspect further comprises an input accepting step of accepting a user input; and when the program contents are displayed on the display unit on the basis of the user input accepted in the input accepting step, the viewing information is recorded on the removable recording medium in the viewing information recording step.

According to a thirteenth aspect of the present invention, in the viewing information recording method of the twelfth aspect, when the user input is accepted for a predetermined period of time in the input accepting step, the viewing information is recorded on the removable recording medium in the viewing information recording step.

According to a fourteenth aspect of the present invention, in the viewing information recording method of the twelfth aspect, an input of information related to the program is accepted in the input accepting step; and when the related information is inputted in the input accepting step, the viewing information is recorded on the removable recording medium in the viewing information recording step.

According to a fifteenth aspect of the present invention, there is provided a computer-readable program recording medium on which a program to make a computer execute the following process steps is recorded: a program accepting step of accepting program contents, and program information having a program identifier to identify programs contents; a display step of displaying the program contents; and a viewing information recording step of recording viewing information having the program identifier to identify the program contents on a removable recording medium, when the program contents are displayed on the display unit.

According to a sixteenth aspect of the present invention, there is provided a removable recording medium on which viewing information is recorded by the viewing information recording method of the eighth aspect.

According to a seventeenth aspect of the present invention, there is provided a service contents decision method for deciding service contents on the basis of viewing information recorded on a removable recording medium.

According to an eighteenth aspect of the present invention, there is provided a viewing information processor for reading viewing information recorded on a removable recording medium, and processing the viewing information, and this processor comprises: a viewing information acquisition unit for reading the viewing information; a service information holding unit for holding service contents in association with a provision condition that is a condition to provide a service specified by the service contents; a service contents decision unit for deciding the service contents, by applying the provision condition held by the service information holding unit to the viewing information obtained by the viewing information acquisition unit; and a service contents output unit for outputting the service contents decided by the service contents decision unit.

According to a nineteenth aspect of the present invention, the viewing information processor of the eighteenth aspect further comprises a viewing information deletion unit for deleting the viewing information recorded on the recording medium, when the service contents output unit outputs the service contents.

According to a twentieth aspect of the present invention, there is provided an information acquisition apparatus for obtaining information from an information server which manages the information, and this apparatus comprises: an acquisition information reader for reading acquisition information, which indicates that information is to be obtained, from a removable recording media on which the acquisition information is recorded; and an information acquisition unit for obtaining the information from the information server when the acquisition information reader obtains the acquisition information.

According to a twenty-first aspect of the present invention, there is provided an information acquisition apparatus for obtaining information from an information server which manages the information in association with an information identifier to identify the information, and this apparatus comprises: an acquisition information reader for reading acquisition information having an information identifier, from a removable recording media on which the acquisition information is recorded; and an information acquisition unit for obtaining, from the information server, the information identified by the information identifier included in the acquisition information.

According to a twenty-second aspect of the present invention, in the information acquisition apparatus of the twenty-first aspect, the acquisition information also includes a frequency indicating the number of times a user can obtain the information; the apparatus further comprises a frequency decrement unit for decrementing the frequency when the information acquisition unit obtains he information; and when the frequency is 1 or more, the information acquisition unit obtains the information.

According to a twenty-third aspect of the present invention, there is provided an information acquisition method for obtaining information from an information server which manages the information, and this method comprises: an acquisition information reading step of reading acquisition information, which indicates that information is to be obtained, from a removable recording media on which the acquisition information is recorded; and an information acquisition step of obtaining the information from the information server when the acquisition information is obtained in the acquisition information reading step.

According to a twenty-fourth aspect of the present invention, there is provided an information acquisition method for obtaining information from an information server which manages the information in association with an information identifier to identify the information, and this method comprises: an acquisition information reading step of reading acquisition information having an information identifier, from a removable recording media on which the acquisition information is recorded; and an information acquisition step of obtaining, from the information server, the information identified by the information identifier included in the acquisition information.

According to a twenty-fifth aspect of the present invention, in the information acquisition method of the twenty-fourth aspect, the acquisition information also includes a frequency indicating the number of times a user can obtain the information in the information acquisition step; the method further comprises a frequency decrement step of decrementing the frequency when the information is obtained in the information acquisition step; and when the frequency is 1 or more, the information is obtained in the information acquisition step.

According to a twenty-sixth aspect of the present invention, there is provided a computer-readable program recording medium on which a program for obtaining information from an information server that manages the information is recorded, and the program makes a computer execute the following process steps: an acquisition information reading step of reading acquisition information, which indicates that information is to be obtained, from a removable recording media on which the acqu0isition information is recorded; and an information acquisition step of obtaining the information from the information server when the acquisition information is obtained in the acquisition information reading step.

According to a twenty-seventh aspect of the present invention, there is provided a recording medium to be mounted on the information acquisition apparatus of the twentieth aspect.

According to a twenty-eighth aspect of the present invention, there is provided a recording medium having an information identifier and a frequency.

According to a twenty-ninth aspect of the present invention, there is provided a transmitter/receiver system comprising: a transmitter for transmitting program contents and a right identifier corresponding to the program contents; a receiver for receiving the program contents and a right identifier transmitted from the transmitter, and recording the right identifier on a removable recording medium; and an information terminal for reading the right identifier recorded on the removable recording medium, and performing a process corresponding to the right identifier; and the receiver comprises: a program acceptor for accepting the program contents and the right identifier; a display unit for displaying the program contents; and a viewing information recorder for recording the right identifier corresponding to the program contents on the removable recording medium, when the program contents are displayed on the display unit.

According to a thirtieth aspect of the present invention, in the transmitter/receiver system of the twenty-ninth aspect, the transmitter transmits the program contents and the right identifier on broadcast waves.

According to a thirty-fifth aspect of the present invention, in the transmitter/receiver system of the twenty-ninth aspect, the transmitter transmits the program contents and the right identifier through a communication network.

According to a thirty-second aspect of the present invention, in the transmitter/receiver system of the twenty-ninth aspect, the information terminal comprises: an identifier acquisition unit for reading the right identifier recorded on the removable recording medium; a service information holding unit for holding service contents in association with a provision condition that is a condition to provide a service decided by the service contents; a service contents decision unit for deciding the service contents, by applying the provision condition held by the service information holding unit to the right identifier obtained by the identifier acquisition unit; and a service contents output unit for outputting the service contents decided by the service contents decision unit.

According to a thirty-third aspect of the present invention, the transmitter/receiver system of the twenty-ninth aspect further comprises an information server which holds information in association with the right identifier transmitted from the transmitter and, on receipt of the right identifier from the information terminal, transmits the information corresponding to the right identifier to the information terminal; and the information terminal transmits the right identifier read from the removable recording medium to the information server, and receives the information corresponding to the transmitted right identifier from the information server.

According to a thirty-fourth aspect of the present invention, in the transmitter/receiver system of the thirty-third aspect, the information terminal comprises: an identifier reader for reading a right identifier from a removable recording medium on which the right identifier is recorded; and an information acquisition unit for transmitting the right identifier to the information server when the identifier reader reads the right identifier to obtain information from the information server.

### BRIEF DESCRIPTION OF THE DRAWINGS

FIG. 1 is a block diagram illustrating the construction of a receiver according to a first embodiment of the invention.

FIG. 2 is a flowchart for explaining the operation of the receiver according to the first embodiment.

FIG. 3 is a diagram illustrating an example of a remote controller.

FIG. 4 is a diagram illustrating an example of viewing information recorded on a recording medium.

FIG. 5 is a block diagram illustrating the construction of a viewing information processor according to a second embodiment.

FIG. 6 is a flowchart for explaining the operation of tine viewing information processor according to the second embodiment.

FIG. 7 is a diagram illustrating an example of provision conditions and service contents that are held by a service information holding unit according to the second embodiment.

FIG. 8 is a diagram illustrating another example of provision conditions and service contents that are held by the service information holding unit according to the second embodiment.

FIG. 9 is a block diagram illustrating the construction of a receiver according to a third embodiment of the invention.

FIG. 10 is a flowchart for explaining the operation of the receiver according to the third embodiment.

FIG. 11 is a diagram illustrating an example of viewing information recorded on a recording medium.

FIG. 12 is a diagram illustrating an example of a monitor on which related information inputted by the user is displayed,

FIG. 13 is a block diagram illustrating the construction of an information acquisition apparatus according to a fourth embodiment of the invention.

FIG. 14 is a flowchart for explaining the operation of the information acquisition apparatus according to the fourth embodiment.

FIG. 15 is a block diagram illustrating the construction of an information acquisition apparatus according to a fifth embodiment of the invention.

FIG. 16 is a flowchart for explaining the operation of the information acquisition apparatus according to the fifth embodiment.

FIG. 17 is a diagram illustrating an example of acquisition information recorded on a recording medium.

FIGS. 18(a) and 18(b) are diagrams illustrating examples of information possessed by an information server.

FIG. 19 is a block diagram illustrating the construction of an information acquisition apparatus according to a sixth embodiment of the invention.

FIG. 20 is a flowchart for explaining the operation of the information acquisition apparatus according to the sixth embodiment.

FIG. 21 is a diagram illustrating an example of acquisition information recorded on a recording medium.

FIG. 22 is a diagram illustrating an example of acquisition information recorded on a recording medium.

FIG. 23 is a block diagram illustrating the construction of a transmitter/receiver system according to a seventh embodiment of the invention.

FIG. 24 is a diagram illustrating the correspondences between program contents and identifiers that are held by a transmitter according to the seventh embodiment.

FIG. 25 is a diagram illustrating the correspondences between identifiers and information that are held by an information server according to the seventh embodiment.

### DETAILED DESCRIPTION OF THE PREFERRED EMBODIMENTS

[Embodiment 1]

Hereinafter, a receiver and a viewing information recording method according to a first embodiment of the present invention will be described with reference to the drawings.

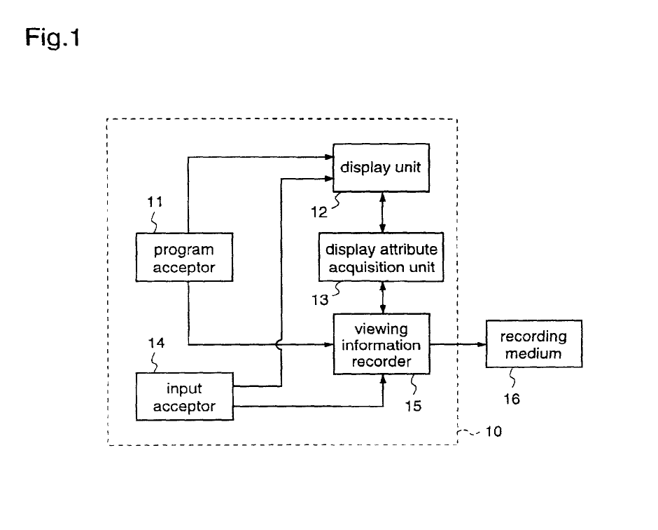

FIG. 1 is a block diagram illustrating the construction of a receiver 10 according to the first embodiment.

The receiver 10 is provided with a program acceptor 11, a display unit 12, a display attribute acquisition unit 13, an input acceptor 14, and a viewing information recorder 15. Reference numeral 16 denotes a removable recording medium.

The program acceptor 11 accepts program information including program contents and a program identifier corresponding to the program contents, which are transmitted on broadcast waves from a broadcast station. Then, the program acceptor 11 outputs the program contents to the display unit 12, and outputs the program identifier to the viewing information recorder 15. The program contents are data constituting a program, and include, for example, either or both of video and audio. The genre of the program contents may be any of CM, drama, animation, sports, etc. The program identifier is an identifier for identifying the program contents, and different program identifiers are assigned to different program contents.

The display unit 12 displays the program contents. The user can arbitrarily decide the display form of the program contents by using a remote controller or the like. The display forms of the program contents are as follows: the ratio of an area where the program contents are displayed to the whole screen of a monitor (e.g., full-screen display or partial-screen display); the size of the area where the program contents are displayed; and the position of the area where the program contents are displayed, on the monitor.

The size of the area where the program contents are displayed is, for example, 2×3 inches. Further, the position of the area where the program contents are displayed on the monitor may be represented by using horizontal and vertical coordinates indicating the upper-left corner of the area with the upper-left corner of the monitor as a point of origin.

When an acquisition command, which instructs acquisition of the display attribute of the program contents, is supplied from the viewing information recorder 15 to the display attribute acquisition unit 13, the acquisition unit 13 obtains the display attribute of the program contents displayed on the display unit 12, and outputs it to the viewing information recorder 15. The display attribute is, for example, any of the display forms described above, or a period of time during which the program is displayed.

The input acceptor 14 accepts an input of a recording signal transmitted from the user by remote control. When the recording signal from the user satisfies a predetermined recording condition, the input acceptor 14 outputs a recording command to the viewing information recorder 15. The recording signal is a signal transmitted from the remote controller to the receiver 10 when the user presses a recording button on the remote controller. The recording condition is a condition for recording viewing information on the recording medium 16, for example, that the user has sent the recording signal continuously for a predetermined period of time or more. The input acceptor 14 also accepts an input from the user, such as a change of the program contents, display form, volume, or the like, and outputs a signal corresponding to the user input to the display unit 12.

The viewing information recorder 15 overwrites the program identifier supplied from the program acceptor 11, in an identifier buffer (not shown). Further, on receipt of the recording command from the input acceptor 14, the recorder 15 outputs an acquisition command to the display attribute acquisition unit 13. Further, on receipt of the display attribute from the display attribute acquisition unit 13, the recorder 15 records the program identifier stored in the identifier buffer as well as the display attribute, on the removable recording medium 16. The removable recording medium 16 is a medium that can be mounted on the receiver 10 when recording the viewing information, and dismounted from the receiver 10 when the recording of the viewing information is ended. The recording medium 16 is, for example, a nonvolatile memory such as a flash memory, a floppy disk, a magnetic disk, an optical disk, a magneto-optical disk, a DVD-RAM, etc.

Next, a description will be given of the operation of the receiver 10, and the viewing information recording method.

First of all, the program acceptor 11 receives broadcast waves from a broadcast station by an antenna (not shown). The broadcast waves contain program contents and a program identifier to identify the program contents. Then, the program acceptor 11 outputs the program contents to the display unit 12, and outputs the program identifier to the viewing information recorder 15. The viewing information recorder 15 stores the program identifier in the identifier buffer.

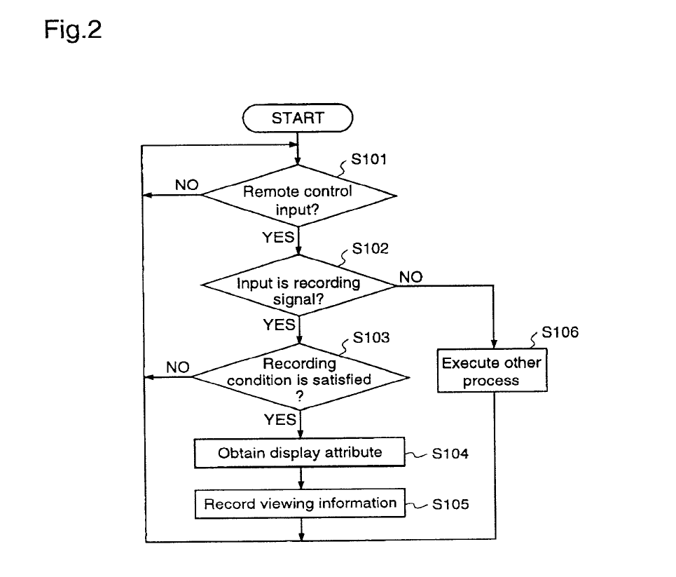

FIG. 2 is a flowchart for explaining the reception of the remote control input from the user by the input acceptor 14, and the recording of the viewing information on the recording medium 16 by the viewing information recorder 15.

Initially, in step S101, the input acceptor 14 checks whether there is a remote control input from the user. When there is no remote control input from the user, the input acceptor 14 repeats the check in step S101. When there is a remote control input from the user, the input acceptor 14 goes to step S102.

In step S102, the input acceptor 14 checks whether the remote control input from the user is a recording signal or not. When it is a recording signal, the acceptor 14 goes to step S103. Otherwise, the acceptor 14 goes to step S106.

In step S103, the input acceptor 14 checks whether the recording signal supplied from the user satisfies the recording condition or not. When the recording signal satisfies the recording condition, the input acceptor 14 outputs a recording command to the viewing information recorder 15, followed by step S104. Otherwise, the input acceptor 14 returns to step S101.

In step S104, on receipt of the recording command from the input acceptor 14, the viewing information recorder 15 outputs an acquisition command to the display attribute acquisition unit 13. On receipt of the acquisition command, the display attribute acquisition unit 13 obtains the display attribute of the program contents displayed on the display unit 12, and outputs it to the reviewing information recorder 15.

In step S105, the viewing information recorder 15 records the display attribute supplied from the display attribute acquisition unit 13 and the program identifier stored in the identifier buffer, as viewing information, or the removable recording medium 16. Thereafter, the operation returns to step S101.

In step S106, the input acceptor 14 outputs a signal inputted from the user, other than the recording signal, to the unit relating to the signal, for example, the display unit 12. The signal other than the recording signal is, for example, a change of the program contents, volume, display form, or the like.

Next, the operation of the receiver 10 will be described more specifically using a concrete example.

In this example, it is assumed that the user is watching a CM of a fast-food company on a television receiver (receiver 10). Accordingly, the program acceptor 11 outputs a program identifier “code 001” corresponding to the CM, to the viewing information recorder 15. The viewing information receiver 15 stores the program identifier “code 001” in the identifier buffer (not shown).

Initially, the user mounts the removable recording medium 16 on the television receiver (receiver 10).

It is assumed that the user, who is watching the CM, displays the CM over the whole screen of the monitor of the television receiver.

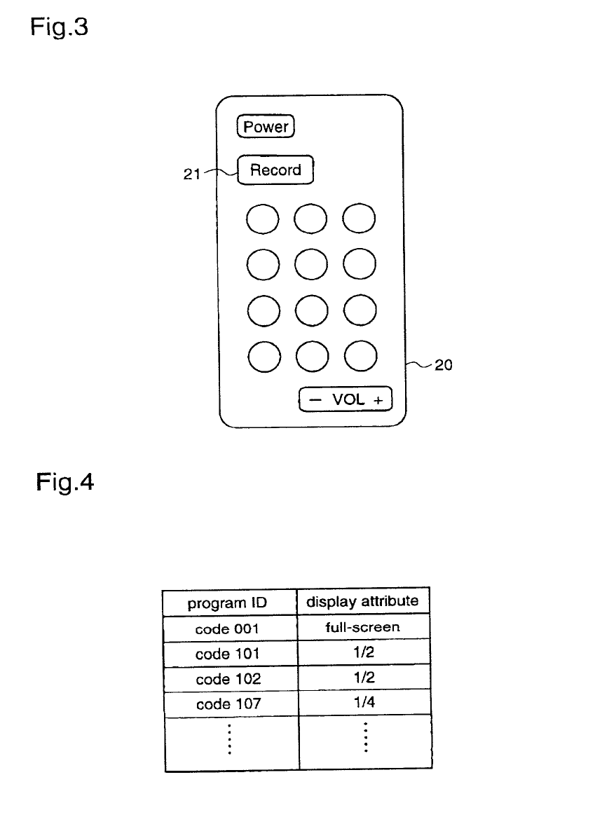

FIG. 3 shows an example of a remote controller 20 used by the user.

The remote controller 20 shown in FIG. 3 has a recording button 21 besides the functions of an ordinary remote controller. When the user watching the CM presses the recording button 21 of the remote controller 20 for a period of time, a recording signal is transmitted from the remote controller 20 to the input acceptor 14 during the period of time. The input acceptor 14 checks whether the signal is a recording signal or not, and whether the transmission of the recording signal has continued for a predetermined period of time (e.g., ten seconds) or more (steps S101, S102, S103). When the recording signal has been inputted for the predetermined period of time or more, the input acceptor 14 outputs a recording command to the viewing information recorder 15. On receipt of the recording command, the viewing information recorder 15 outputs an acquisition command to the display attribute acquisition unit 13. Then, the display attribute acquisition unit 13 obtains the display attribute that the CM is displayed over the whole screen of the monitor, and outputs the display attribute to the viewing information recorder 15. The viewing information recorder 15 records the display attribute and the program identifier stored in the identifier buffer, on the recording medium 16 (steps S104 and S105).

In this way, the information that the user has viewed the CM of the fast-food company (viewing information) is recorded on the recording medium 16.

FIG. 4 is a diagram illustrating examples of program identifiers and display attributes recorded on the recording medium 16.

The program identifiers are shown in the left column of FIG. 4. The ratios of the program display areas to the whole screen of the monitor are shown as the display attributes on the right column of FIG. 4. With reference to FIG. 4, for example, a program identifier “code 001” as information that the user viewed a CM of a fast-food company, is associated with a display attribute indicating that the CM was displayed over the whole screen of the monitor.

The user can take the recording medium 16 on which the viewing information is recorded out of the television receiver (receiver 10) to carry it at will.

Next, the operation of the receiver 10 will be described using another example.

In the example described hereinafter, it is assumed that the user is watching a baseball game on the television receiver (receiver 10). Accordingly, a program identifier “code 101” corresponding to the baseball game is outputted from the program acceptor 11 to the viewing information recorder 15. The viewing information recorder 15 stores the program identifier “code 101” in the identifier buffer (not shown).

Initially, the user mounts the removable recording medium 16 on the television receiver (receiver 10).

It is assumed that the user, who is watching the baseball game, displays the baseball game on the half screen of the monitor of the television receiver.

When the user watching the baseball game presses the recording button 21 of the remote controller 20 for a period of time, a recording signal is transmitted from the remote controller 20 to the input acceptor 14 of the receiver 10 during the period of time. Then, the input acceptor 14 checks whether the signal is a recording signal or not, and whether the transmission of the recording signal has continued for a predetermined period of time (e.g., ten seconds) or more (steps S101, S102, S103). When the recording signal has been inputted for the predetermined period of time or more, the input acceptor 14 outputs a recording command to the viewing information recorder 13. On receipt of the recording command, the viewing information recorder 15 outputs an acquisition command to the display attribute acquisition unit 13. Then, the display attribute acquisition unit 13 obtains the display attribute that the baseball game is displayed on the half screen of the monitor, and outputs it to the viewing information recorder 15. Then, the viewing information recorder 15 records the display attribute and the program identifier stored in the identifier buffer, on the recording medium 16 (steps S104, S105).

Every time the user views a baseball game, the user can record the information that he/she has viewed the baseball game, on the recording medium 16.

In this way, the information that the user has viewed the baseball game (viewing information) is recorded on the recording medium 16 as shown in FIG. 4. The user can dismount the recording medium 16 on which the viewing information is recorded from the television receiver (receiver 10) to carry it at will.

As described above, the receiver 10 of this first embodiment is provided with the viewing information recorder 15 for recording a program identifier to identify a program and a display attribute indicating the display form of the program, on the removable recording medium 16, when a recording signal from the user is inputted continuously for a predetermined period of time. Therefore, the information that the user has viewed a specific program can be recorded on the removable recording medium 16. The user, who carries the recording medium 16 containing the viewing information, can receive various kinds of services corresponding to the viewing information.

Although, in the concrete example of the first embodiment, the ratio of the area where the program contents are display to the monitor screen is employed as the display attribute to be recorded on the recording medium, 16, this is merely an example. The display attribute may be, for example, the size or position of the area where the program contents are displayed, or the time during which the program contents are displayed. Further, a combination of plural display attributes may be recorded on the recording medium 16.

Further, while the receiver 10 of this first embodiment is provided with the display attribute acquisition unit 13 and the input acceptor 14, the receiver 10 can be constituted without the display attribute acquisition unit 13. In this case, the viewing information to be recorded on the recording medium 16 includes no display attribute. Furthermore, while in the above description the viewing information is recorded on the recording medium 16 when the receiver 10 receives an input of a recording signal or the like from the user, the viewing information may be recorded on the recording medium 16 when the user displays the program contents on the display unit 12 or when the user displays the program contents in a specific display form on the display unit 12.

[Embodiment 2]

Hereinafter, a viewing information processor and a service content decision method according to a second embodiment of the invention will be described with reference to the drawings.

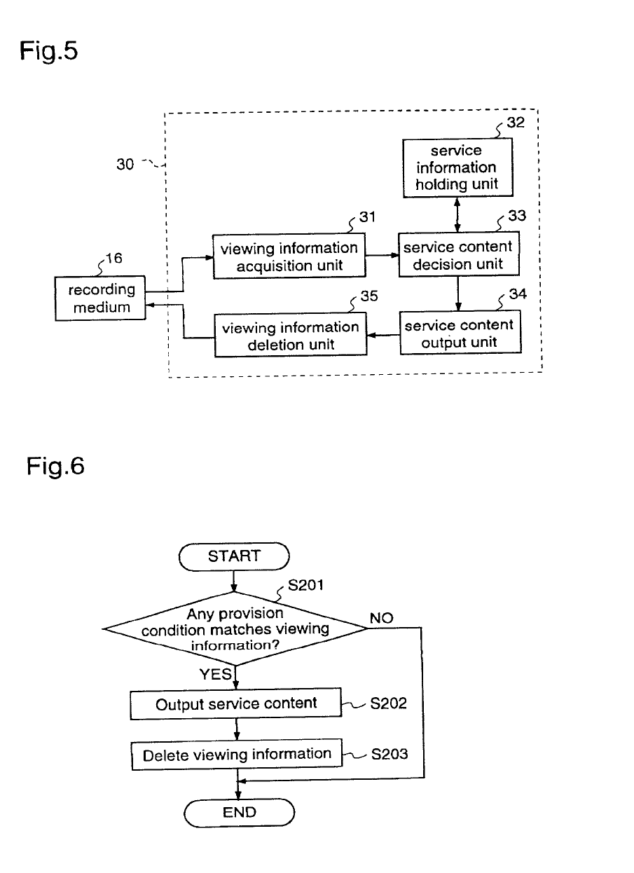

FIG. 5 is a block diagram illustrating the construction of a viewing information processor 30 according to the second embodiment.

The viewing information processor 30 is composed of a viewing information acquisition unit 31, a service information holding unit 32, a service content decision unit 33, a service content output unit 34, and a viewing information deletion unit 35. Reference numeral 16 denotes a removable recording medium.

The viewing information acquisition unit 31 obtains viewing information from the removable recording medium 16, and outputs it to the service contents decision unit 33. The viewing information is, as described for the first embodiment, information including a program identifier. The service information holding unit 32 holds service information comprising a provision condition that is a condition for providing the user with a service, and service contents corresponding to the provision condition. The service contents decision unit 33 decides whether there is a provision condition that matches the viewing information supplied from the viewing information acquisition unit 31, with reference to the service information holding unit 32. When there is a provision condition that matches, the service contents decision unit 33 outputs service contents corresponding to the provision condition and a program identifier corresponding to the service contents, to the service contents output unit 34. The program identifier corresponding to the service contents is a program identifier that is specified by the provision condition and is required for receiving the service.

The service contents output unit 34 outputs the service contents supplied from the service contents decision unit 33, and outputs the program identifier corresponding to the service contents to the viewing information deletion unit 35. To output the service contents is a concept including the case of suggesting the service contents by some method, or the case of directly distributing a service. On receipt of the program identifier corresponding to the service contents from the service content output unit 34, the viewing information deletion unit 35 deletes the program identifier from the viewing information recorded on the recording medium 16.

Next, a description will be given of the operation of the viewing information processor 30.

First of all, when the removable recording medium 16 is mounted on the viewing information processor 30, the viewing information acquisition unit 31 reads the viewing information recorded on the recording medium 16, and outputs it to the service contents decision unit 33.

FIG. 6 is a flowing chart for explaining the operation of the viewing information processor 30 to decide and output the service contents, after the service contents decision unit 33 has received the viewing information.

First of all, in step S201, the service contents decision unit 33 decides whether there is a provision condition that matches the viewing information supplied from the viewing information acquisition unit 31, with reference to the service information holding unit 32. When there is a provision condition that matches, the service contents decision unit 33 takes service contents corresponding to the provision condition and a program identifier corresponding to the service contents, from the service information holding unit 32, and outputs them to the service contents output unit 34. When there is no provision condition that matches, the operation is ended and, thereafter, the viewing information processor 30 is in the stand-by state until new viewing information is inputted.

In step S202, the service contents output unit 34 outputs the service contents supplied from the service contents decision unit 22. Then, the service contents output unit 34 outputs the program identifier corresponding to the service contents to the viewing information deletion unit 35.

In step S203, the viewing information deletion unit 35 deletes, from the removable recording medium 16, the viewing information including the program identifier supplied from the service contents output unit 34 in step S202.

Next, the operation of the viewing information processor 30 will be described using a concrete example.

In this example, the removable recording medium 16 contains viewing information that the user has viewed a CM of a fast-food company (i.e., a program identifier “code 001”) as described for the first embodiment, and the user, who has recorded the viewing information on the recording medium 16, goes to a fast-food shop of the fast-food company with the recording medium 16.

A clerk of the fast-food shop receives the recording medium 16 from the user, and mounts it on the viewing information processor 30. Then, the viewing information acquisition unit 31 reads the viewing information and outputs it to the service contents decision unit 33. The service contents decision unit 33 decides whether there is a provision condition that matches the viewing information that the user has viewed the CM of the fast-food company, with reference to the service information holding unit 32.

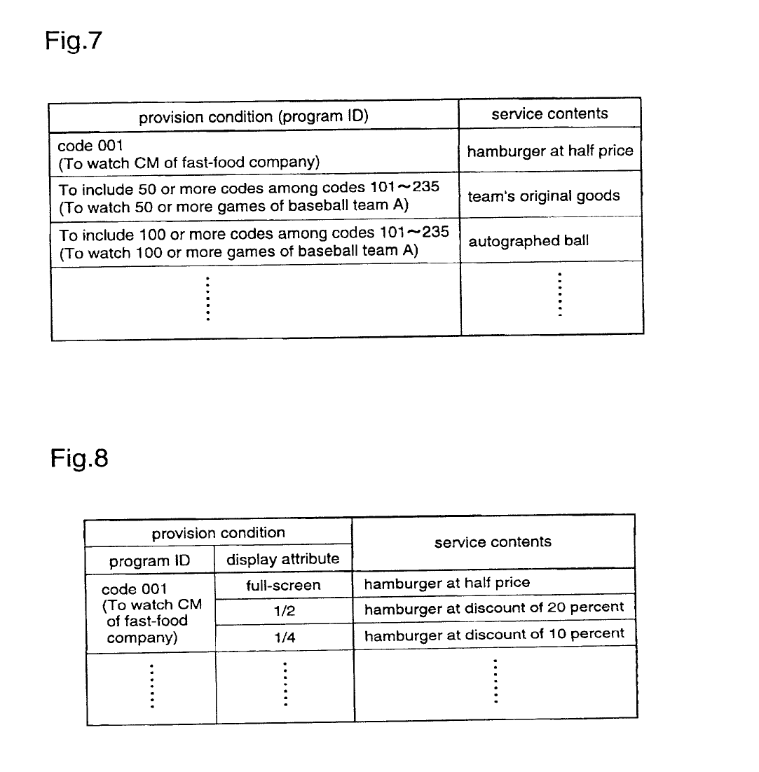

FIG. 7 is a diagram illustrating examples of provision conditions and service contents, which are stored in the service information holding unit 32.

In FIG. 7, program identifiers as provision conditions are shown in the left column, and service contents corresponding to the provision conditions are shown in the right column. In the column of the provision conditions, the terms inside the parentheses are added for explanation only, and these terms are not actually included in the provision conditions held by the service information holding unit 32.

At this time, since the service information holding unit 32 holds the provision condition corresponding to the CM of the fast-food company, i.e., the program identifier “code 001”, the service contents decision unit 33 decides that there is a provision condition that matches the viewing information, and outputs the service contents that the price of a hamburger is reduced by half (step S201) The decision as to whether there is a provision condition that matches the viewing information is carried out by confirming whether the viewing information includes an identifier that matches the program identifier “code 001” included in the provision condition.

Then, the service contents output unit 34 displays that the price of a hamburger is reduced by half, on the monitor in front of the user, and outputs the program identifier “code 001” corresponding to the service contents to the viewing information deletion unit 35 (step S202). Then, the viewing information deletion unit 35 deletes the program identifier “code 001” corresponding to the CM of the fast-food company, from the viewing information recorded on the recording medium 16 (step S203).

Thereby, the user can get a hamburger at half price and, thereafter, receives the recording medium 16 from the clerk.

Next, the operation of the viewing information processor 30 will be described using another concrete example.

In this example, the removable recording medium 16 contains viewing information that the user has viewed baseball games of baseball team A as described for the first embodiment, and the user, who has recorded the viewing information on the recording medium 16, goes to the place where a meeting of fan thanks day of baseball team A is held, with the recording medium 16.

A staff member of the meeting receives the recording medium 16 from the user, and mounts it on the viewing information processor 30. Then, the viewing information acquisition unit 31 reads the viewing information, and outputs it to the service contents decision unit 33. The service contents decision unit 33 decides whether there is a provision condition that matches the viewing information that the user has viewed the baseball games, with reference to the service information holding unit 32.

It is assumed that 87 pieces of program identifiers corresponding to the baseball games of team A in this year are recorded on the recording medium 16 possessed by the user. That is, the user has viewed 87 games of team A in one year.

As shown in FIG. 7, the service information holding unit 32 holds a provision condition that the viewing information should include 50 or more program identifiers among program identifiers “code 101” to “code 235” corresponding to the baseball games of team A in this year. Therefore, the service contents decision unit 33 decides hat there is a provision condition that matches the viewing information, and outputs the service contents indicating that the user can get the original goods of team A, to the service contents output unit 33 (step S201). The decision as to whether there is a provision condition that matches the viewing information is carried out by checking how many program identifiers are included in the viewing information, among the program identifiers “code 101” to “code 235” corresponding to the total 135 games of team A in one year.

Then, the service contents output unit 34 displays that the user can get the original goods of team A, on the monitor in front of the user, and outputs the 50 program identifiers corresponding to the service contents to the viewing information deletion unit 35 (step S202). Then, the viewing information deletion unit 35 deletes the 50 program identifiers relating to the baseball games recorder on the recording medium 16, from the viewing information (step S203).

Thus, the user can get the original goods and, thereafter, receives the recording medium 16 from the staff member.

As described above, according to the viewing information processor 30 and the service contents decision method of the second embodiment, the viewing information recorded on the recording medium 16 is read out, and it is decided whether the viewing information matches any of the provision conditions held in the service information holding unit 32, and the corresponding service contents are outputted when there is a match. Thereby, it is possible to provide the user with a minute service on the basis of the information that the user has viewed a specific program.

Furthermore, since the viewing information deletion unit 35 deletes the viewing information after the service contents are outputted, the user is inhibited from receiving the same service plural times by using the same viewing information.

While in this second embodiment the service contents output unit 34 outputs the service contents and, simultaneously, outputs the program identifier corresponding to the service contents to the viewing information deletion unit 35, this is merely an example. When there are two or more provision conditions that match the viewing information, the service contents output unit 34 initially requests the user to select one of plural services, and then outputs the program identifier corresponding to the service contents selected by the user, to the viewing information deletion unit 35.

While in this second embodiment the service information holding unit 32 holds the provision conditions relating to the program identifiers only, the holding unit 32 may hold provision conditions relating to the program identifier and the display attributes. There may be a single display attribute or plural display attributes to be used as the provision condition.

FIG. 8 is a diagram illustrating examples of provision conditions and the corresponding service contents, which are held by the service information holding unit 32.

Each of the provision conditions shown in FIG. 8 is composed of a program identifier and a display attribute, and the user can be provided with a service corresponding to each condition. For example, the user having the recording medium 16 on which the viewing information shown in FIG. 4 is recorded as described for the first embodiment can be provided with the service that the price of a hamburger is reduced by half, according to the service information shown in FIG. 8.

Further, it is possible to limit a period of time during which the user can receive a service by periodically updating the provision condition held by the service information holding unit 32. For example, with respect to the provision of the service “hamburger at half price”, “code 501” is assigned to a period from January to June in 2001 and “code 502” is assigned to a period from July to December in 2001, whereby the user having a recording medium on which the “code 501” is recorded should receive the service until the end of June, 2001.

Further, when the viewing information is encrypted and then recorded on the recording medium 16, the viewing information acquisition unit 31 decrypts it and output the decrypted viewing information to the service contents decision unit 33.

While in this second embodiment the user goes to the fast-food shop or the like with the recording medium 16 on which the viewing information is recorded, and receives the service such as a discount on the price of a hamburger through the clerk, this is merely an example, and the user may mount the recording medium 16 by himself/herself on a machine placed in the fast-food shop to automatically receive a service of any drink or food.

The service in this second embodiment is not restricted to a predetermined bonus (e.g., discount on the price of a hamburger, etc.) or a predetermined item (e.g., food, drink, original goods of a baseball team, etc.), and it is a large concept including provision of information, such as provision of video or audio, or provision of the right to play a game. When the service is such information, the user may view the video, listen to the music, or play the game by using the viewing information processor. Alternatively, the user may record the provided information on a predetermined removable recording medium to utilize the information at his/her desired place.

Furthermore, the user may obtain viewing information by viewing a predetermined program, or the user may purchase viewing information corresponding to a service he/she desires. As the purchasing method, the user may purchase a recording medium on which viewing information is already recorded, or the user may record desired viewing information on a recording medium possessed by the user, through network or predetermined equipment, by paying a charge for the viewing information.

Furthermore, while in this second embodiment the viewing information is deleted after the corresponding service is provided, the viewing information should not be deleted if plural services are to be provided by the same viewing information.

[Embodiment 3]

Hereinafter, a receiver and a viewing information recording method according to a third embodiment of the present invention will be described with reference to the drawings.

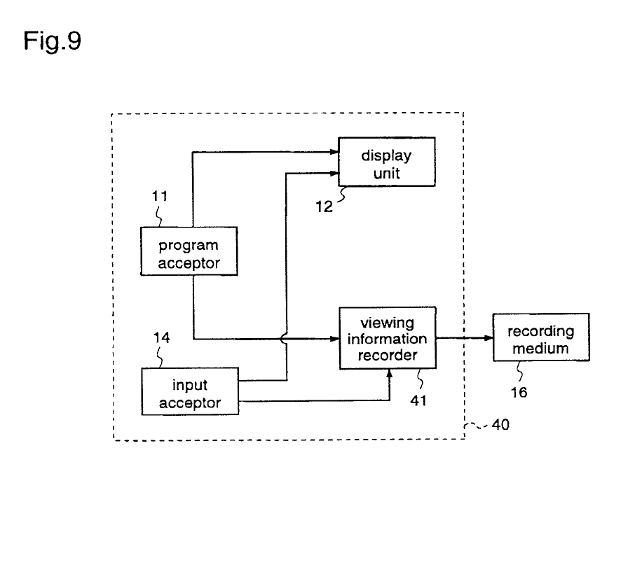

FIG. 9 is a block diagram illustrating the construction of a receiver 40 according to the third embodiment.

The receiver 40 is provided with a program acceptor 11, a display unit 12, an input acceptor 14, and a viewing information recorder 41. The program acceptor 11, the display unit 12, and the input acceptor 14 are identical to those already described for the first embodiment and therefore, do not require repeated description.

The viewing information recorder 41 overwrites the program. identifier supplied from the program acceptor 11 in an identifier buffer (not shown). On receipt of a recording command supplied from the input acceptor 14, the viewing information recorder records the program identifier on the removable recording medium 16. When the viewing information recorder 41 of this third embodiment records the same program identifier on the recording medium 16, it does not record the same identifier plural times, but increments the number of times of viewing corresponding to the program identifier.

Next, the operation of the receiver 40 and the viewing information recording method will be described.

First of all, the program acceptor 11 receives broadcast waves from a broadcast station by an antenna (not shown). The broadcast waves include program contents and a program identifier to identify the program contents. Then, the program acceptor 11 outputs the program contents to the display unit 12, and outputs the program identifier to the viewing information recorder 41. The viewing information recorder 41 stores the program identifier in the identifier buffer.

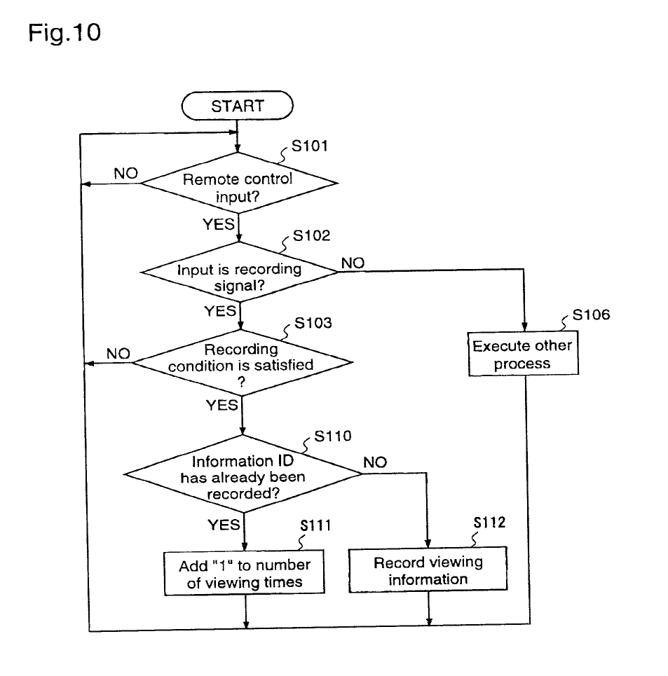

FIG. 10 is a flowchart for explaining the operation of the input acceptor 14 to receive the user's remote control input, and the operation of the viewing information recorder 41 to write the viewing information on the recording medium 16. In FIG. 10, the process steps other than steps S110 to S112 are identical to those in the flowchart shown in FIG. 2 according to the first embodiment except that the viewing information recorder 41 is used instead of the viewing information recorder 15 of the first embodiment and, therefore, repeated description is not necessary.

In step S110, the viewing information recorder 41 checks whether or not the program identifier stored in the identifier buffer has already been recorded on the recording medium 16. When it has already been recorded, the recorder 41 goes to step S111. When it has not been recorded yet, the recorder 41 goes to step S112.

In step S111, the viewing information recorder 41 adds “1” to the number of viewing times corresponding to the program identifier stored in the identifier buffer, among the numbers of viewing times recorded on the recording medium 16, and then returns to step S101.

In step S112, the viewing information recorder 41 records the program identifier stored in the identifier buffer, as viewing information, on the removable recording medium 16. When recording the viewing information, the number of viewing times corresponding to the recorded program identifier is “1”. Thereafter, the recorder 41 returns to step S101.

Next, the operation of the receiver 40 will be described using a concrete example.

In the example described hereinafter, it is assumed that the user is viewing a CM of a fast-food company on a television receiver (receiver 40) Accordingly, the program acceptor 11 outputs a program identifier “code 001” corresponding to the CM to the viewing information recorder 15. Then, the viewing information recorder 15 stores the program identifier “code 001” in the identifier buffer (not shown).

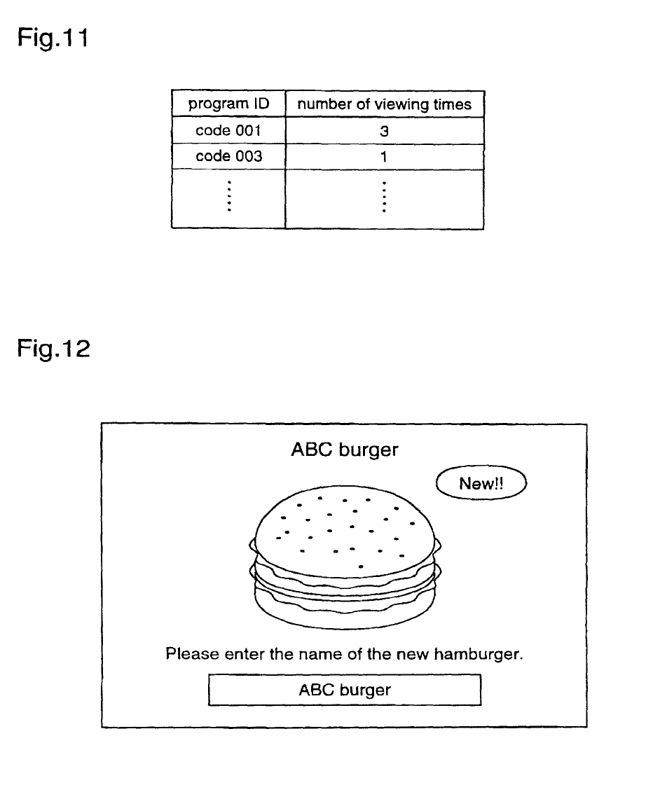

FIG. 11 is a diagram illustrating examples of program identifiers and the corresponding number of viewing times, which are recorded on the removable recording medium 16.

In FIG. 11, the program identifiers are shown in the left column. The number of viewing times, indicating how many times the user has viewed the program corresponding to each program identifier, is shown in the right column. For example, the program identifier “code 001” indicating that the viewer has viewed the CM of the fast-food company, and the number of viewing times “3” indicating that the viewer has viewed the CM three times, are recorded on the recording medium 16.

Initially, the user mounts the removable recording medium 16 on which the viewing information shown in FIG. 11 is recorded, on the television receiver (receiver 40).

When the user, who is viewing the CM, presses the recording button 21 of the remote controller 20 shown in FIG. 3 for a period of time, a recording signal is transmitted from the remote controller 20 to the input acceptor 14 of the receiver 40 during the period of time. Then, the input acceptor 14 checks whether the signal is a recording signal or not, and whether the recording signal has continued for a predetermined period of time (e.g., ten seconds) (steps S101, S102, S103). When the inputting of the recording signal has continued for the predetermined period of time or more, the input acceptor 14 outputs a recording command to the viewing information recorder 41. The viewing information recorder 41 receives the recording command. Since the “code 001” has already been recorded on the recording medium 16, the viewing information recorder 41 decides that the program identifier “code 001” stored in the identifier buffer has already been recorded on the recording medium 16 (step S110), and adds “1” to the number of viewing times corresponding to the program identifier “code 001” (step S111). Thereby, the number of times of viewing corresponding to the program identifier “code 001” becomes “4”.

In this way, the viewing information that the user has viewed the CM of the fast-food company four times is recorded on the recording medium 16, and the user can take the recording medium 16 on which the viewing information is recorded out of the television receiver (receiver 40) to carry it at will.

As described above, the receiver 40 according to the third embodiment is provided with the viewing information recorder 41 for recording, on the recording medium 16, a program identifier to identify a program, and the number of viewing times indicating how many times the user has viewed the program. Therefore, in addition to the effects of the first embodiment, the number of times the user has viewed a specific program car be recorded on the removable recording medium 16. The user, who carries he viewing information including the number of viewing times, can receive various kinds of services corresponding to the viewing information.

The receiver 40 according to the third embodiment may be provided with the display attribute acquisition unit 13 described for the first embodiment. In this case, a program identifier, the corresponding display attribute, and the corresponding number of viewing times are recorded on the removable recording medium 16.

While in the first to third embodiments the program acceptor 11 receives a program which has been broadcast from a broadcast station, this is merely an example, and the program acceptor 11 may receive information as a program from a network, such as the Internet, through a communication line. Accordingly, the program described in this specification is a concept including not only TV programs but also information that is available through networks. Further, the program may include audio. Furthermore, the receivers 10 and 40 according to the first and third embodiments are not restricted to the television receivers. Any equipment, such as a personal computer or a work station, may be employed so long as it can display a program and record viewing information on a recording medium.

While in the first and third embodiment the input acceptor 14 outputs a recording command to the viewing information recorder 15 or 41 when the user has pressed the recording button 21 of the remote controller 20 for a predetermined period of time or more, this is merely an example. The input acceptor may output a recording command to the viewing information recorder 15 or 41 when the user inputs characters or the like including related information by using the remote controller, or when the user accesses an URL presented by the program contents. The related information is information related to the contents of the program the user watches. When the user watches a CM of a fast-food company, the related information is, for example, the name of the fast-food company or its abbreviation. When the user inputs characters or the like including the information related to the program, the user can clearly memorize the contents of the CM, thereby enhancing the effect of the CM. The related information may be a number or the like indicated in the program. In this case, the user's inputting the number or the like by the remote controller is equivalent to inputting the related information.

Hereinafter, a description will be given of the process of the input acceptor 14 to decide whether the related information supplied from the user is correct or not. The program provider has previously transmitted plural pieces of information related to the program contents to the receiver 10 or 40. When the user inputs related information, the input acceptor 14 checks whether the related information inputted by the user matches any of the plural pieces of related information supplied from the program provider. Thereby, the input acceptor 14 decides whether the related information inputted by the user is correct or not. Even when the related information inputted by the user is not completely correct, the input acceptor 14 may decide that the related information is correct if there is compatibility higher than a predetermined percentage, for example, 80%. Alternatively, it is also possible to make the user input the related information by displaying, on the monitor, an instruction to input the related information. For example, in the case of the CM of the fast-food company, an instruction such a, “Please enter the name of the company” or “Please enter the name of the new hamburger” is displayed on the monitor. When the user performs correct data entry, the viewing information is recorded on the recording medium 16.

FIG. 12 is a diagram illustrating an example of a monitor on which related information entered by the user is displayed.

With reference to FIG. 12, in a CM of a fast-food company, it is displayed that “ABC hamburger” is a new product, and the user is requested to enter the name of the new hamburger. When the user enters “ABC hamburger” using the remote controller in response to this request, the entered contents are displayed on the monitor. In this way, the user can confirm the related information entered by him/herself on the monitor.

Further, in the first and third embodiments, programs viewed by the user may be stored in a program storage unit (not shown). In this case, the input acceptor 14 may output a recording command to the viewing information recorder 15 or 41 when the user selects any of the stored programs and displays it on the display unit 12, or when any of the stored programs is displayed on the display unit 12 according to a display command transmitted from the broadcast station or according to a time which has previously been set in the receiver 10 or 40.

Furthermore, whale in the first and third embodiments the viewing information recorder 15 or 41 records the viewing information directly on the recording medium 16, this is merely an example, and the viewing information recorder 15 or 41 may temporarily store the viewing information in a storage unit (not shown) possessed by the receiver 10 or 40, and the recorder may record the stored viewing information on the removable recording medium 16 at the request of the user.

Furthermore, in the first and third embodiments, the viewing information recorder 15 or 41 may encrypt the viewing information when recording it on the recording medium 16. In this case, the contents on the recording medium 16 are prevented from being rewritten.

Moreover, while in the first and third embodiments the user performs input to the input acceptor 14 by using the remote controller, this is merely an example. The user input may be performed by using a keyboard or the like connected to the receiver 10 or 40, such as a keyboard connected to a personal computer, or a touch panel or the like. The method of user input is not restricted. The user input is data entry to the receiver 10 or 40, performed by the user with the remote controller, keyboard, etc.

When the receiver 10 or 40 is used by plural users, since plural pieces of viewing information corresponding to the users are recorded on one recording medium 16, user's identifiers and the corresponding viewing information may be recorded on the recording medium 16.

While in the first to third embodiments the programs accepted by the program acceptor 11 and the service contents offered to the user are described in relation to the fast food and the baseball, these are merely examples, and other programs and services relating to dramas, movies, sports, news, and advertisements are also within the scope of the present invention.

[Embodiment 4]

Hereinafter, an information acquisition apparatus and an information acquisition method according to a fourth embodiment of the present invention will be described with reference to the drawings.

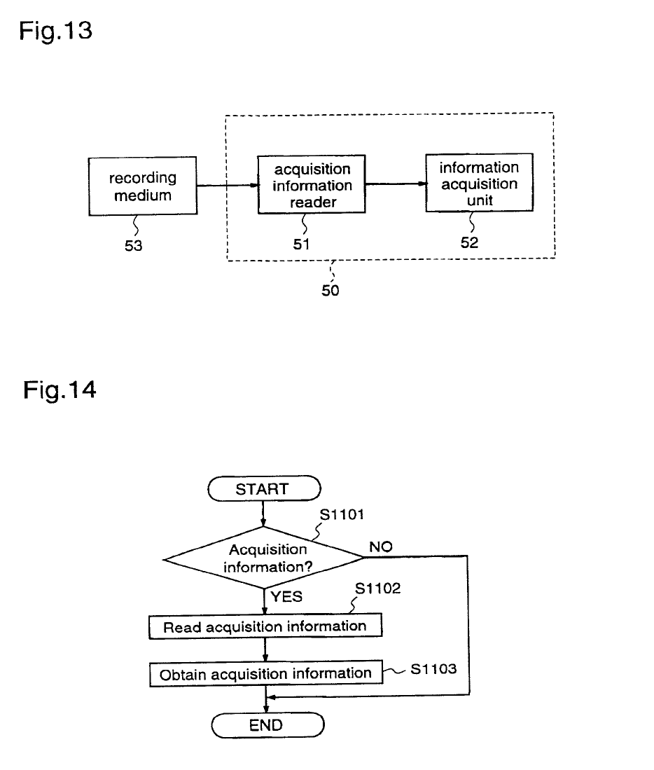

FIG. 13 is a block diagram illustrating the construction of an information acquisition apparatus 50 according to the fourth embodiment of the present invention.

The information acquisition apparatus 50 is provided with acquisition information reader 51 and an information acquisition unit 52.

The acquisition information reader 51 reads acquisition information from a removable recording medium 53. The acquisition information indicates that information is to be obtained from an information server (not shown) which manages the information. The information acquisition unit 52 obtains information from the information server through a communication line when the acquisition information reader 51 has read the acquisition information. The communication line is, for example, a telephone line.

Next, the operation of the information acquisition apparatus 50 and the information acquisition method will be described.

FIG. 14 is a flowchart for explaining the operation of the information acquisition apparatus 50 after the removable recording medium 53 is mounted on the information acquisition apparatus 50.

In step S1101, the acquisition information reader 51 checks whether acquisition information is recorded on the recording medium 53 mounted on the information acquisition apparatus 50. When it is recorded, the reader 51 goes to step S1102. Otherwise, the operation is ended.

In step S1102, the acquisition information reader 51 reads the acquisition information from the recording medium 53, and informs the information acquisition unit 52 that the acquisition information has been read.

In step S1103, the information acquisition unit 52 obtains information from the information server (not shown).

Next, the operation of the information acquisition apparatus 50 will be described using a concrete example.

In the example described hereinafter, it is assumed that the user, having the recording medium 53 on which the acquisition information is recorded, obtains music as information.

Initially, the user mounts the recording medium 53 on which the acquisition information is recorded, on the information acquisition apparatus 50 placed at a corner of a convenience store.

Then, the acquisition information reader 51 of the information acquisition apparatus 50 decides that the acquisition information is recorded on the recording medium 53 (step S1101), reads the acquisition information, and informs the information acquisition unit 52 that it has obtained the acquisition information (step S1102).

On receipt of the information that the reader 51 has obtained the acquisition information, the information acquisition unit 52 obtains music data from the information server (not shown), and records the music data on the recording medium 53 by a recorder (not shown).

In this way, the user, who has mounted the recording medium 53 containing the acquisition information on the information acquisition apparatus 50, can obtain the recording medium 53 on which the music data is recorded. When the user mounts the recording medium 53 on a player, he/she can listen to the music.

As described above, according to the information acquisition apparatus and the information acquisition method of this fourth embodiment, the acquisition information is read from the recording medium 53 on which the acquisition information is recorded, and the information is obtained from the information server, whereby the user can obtain the information without paying a predetermined amount of money to the information acquisition apparatus 50. Further, since the information is obtained from the information server connected to the information acquisition apparatus 50 through the communication line, the user can obtain the latest information.

[Embodiment 5]

Hereinafter, an information acquisition apparatus and an information acquisition method according to a fifth embodiment of the invention will be described with reference to the drawings.

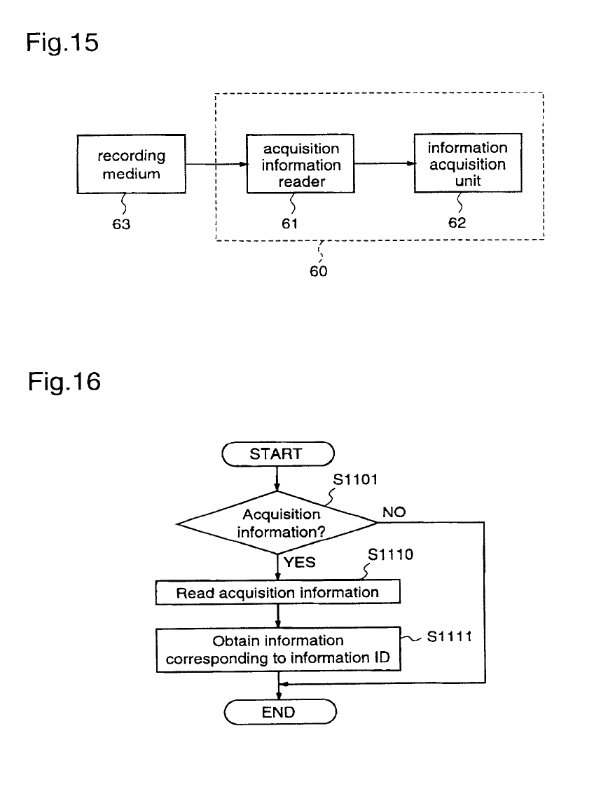

FIG. 15 is a block diagram illustrating the construction of an information acquisition apparatus 60 according to the fifth embodiment.

The information acquisition apparatus 60 is provided with an acquisition information reader 61, and an information acquisition unit 62.

The acquisition information reader 61 reeds acquisition information from a removable recording medium 63. The acquisition information indicates that information is to be obtained from an information server (not shown) which manages the information, and the acquisition information of this fifth embodiment includes an information identifier to identify information. After the acquisition information reader 61 reads the acquisition information, the information acquisition unit 62 obtains information specified by the information identifier included in the acquisition information, from the information server (not shown) through a communication line.

Next, the operation of the information acquisition apparatus and the information acquisition method will be described.

FIG. 16 is a flowchart for explaining the operation of the information acquisition apparatus 60 after the removable recording medium 63 is mounted on the information acquisition apparatus 60. The process in step S1101 is identical to that in the flowchart of the fourth embodiment shown in FIG. 14 except that the acquisition information reader 51, the information acquisition unit 52, and the recording medium 53 according to the fourth embodiment are replaced with the acquisition information reader 61, the information acquisition unit 62, and the recording medium 63, respectively.

In step S1110, the acquisition information reader 61 reads acquisition information including an information identifier from the recording medium 16, and outputs the acquisition information to the information acquisition unit 62.

In step S1111, the information acquisition unit 62 obtains, from the information server (not shown), information corresponding to the information identifier included in the acquisition information supplied from the acquisition information reader 61.

Next, the operation of the information acquisition apparatus 60 will be described using a concrete example.

The following example will be described for the case where the user having the recording medium 63 on which the acquisition information is recorded, obtains information from the information server.

Initially, it is assumed that the user mounts the recording medium 63, on which the acquisition information including an information identifier is recorded, on the information acquisition apparatus 60 placed at a corner of a convenience store.

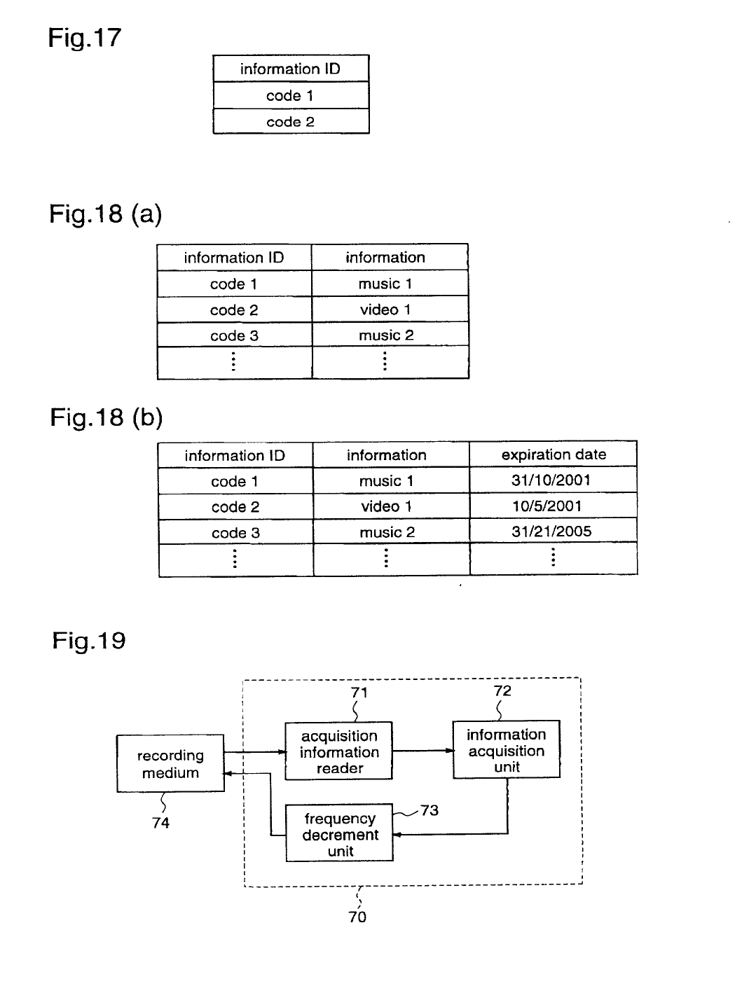

FIG. 17 is a table illustrating an example of acquisition information recorded on the recording medium 63.

With reference to FIG. 17, an information identifier “code 1” and an information identifier “code 2” are recorded, as information identifiers included in the acquisition information, on the recording medium 63 possessed by the user.

Then, the acquisition information reader 61 of the information acquisition apparatus 60 decides that the acquisition information is recorded on the recording medium 63 (step S1101), reads the acquisition information, and outputs the acquisition information including the information identifiers “code 1” and “code 2” to the information acquisition unit 62 (step S1110).

FIG. 18(a) is a diagram illustrating information identifiers stored in the information server (not shown) and the corresponding information.

With reference to FIG. 18(a), plural pieces of information, such as music data “music 1”, video data “video 1”, and the like, are stored in association with the information identifiers, in the information server.

The information acquisition unit 62 transmits the information identifiers “code 1” and “code 2” supplied from the acquisition information reader 61, through the communication line to the information server, and obtains the music data “music 1” and the video data “video 1” from the information server, and records the obtained music data and video data on the recording medium 63 by a recorder (not shown).

In this way, the user, who has mounted the recording medium 63 containing the acquisition information on the information acquisition apparatus 60, can obtain the music data and the video data recorded on the recording medium 63, and the user can listen to the music and view the video.

Further, expiration dates may be set on the information identifiers and the corresponding Information stored in the information server.

FIG. 18(b) is a diagram illustrating information identifiers, the corresponding information, and the expiration dates of the information, which are stored in the information server (not shown).

In this case, the information server checks whether the date when it receives the information identifier from the information acquisition unit 60 is before the expiration date corresponding to the information identifier or not. When the reception date is before the expiration date, the server distributes the information to the information acquisition apparatus 60. When the reception date is past the expiration date, the server does not distribute the information to the apparatus 60. In this way, a period of time during which the information identifier is available can be set by associating the information identifier with the expiration date.

As described above, in the information acquisition apparatus 60 and the information acquisition method according to the fifth embodiment, since the user obtains desired information by using the recording medium 63 on which the acquisition information including plural information identifiers are recorded, the user possessing the recording medium 63 can obtain plural pieces of information corresponding to the information identifiers, in addition to the effect of the fourth embodiment.

While in this fifth embodiment the plural pieces of information corresponding to all of the information identifiers included in the acquisition information on the recording medium 63 are obtained from the information server, this is merely an example, and the possessor of the recording medium 63 may select one or some of the information identifiers recorded on the recording medium 63 to obtain one or plural pieces of information corresponding to the selected information identifier/identifiers from the information server.

[Embodiment 6]

Hereinafter, an information acquisition apparatus and an information acquisition method according to a sixth embodiment of the present invention will be described with reference to the drawings.

FIG. 19 is a block diagram illustrating the construction of an information acquisition apparatus 70 according to the sixth embodiment of the invention.

The information acquisition apparatus 70 is composed of an acquisition information reader 71, an information acquisition unit 72, and a frequency decrement unit 73.

The acquisition information reader 71 reads acquisition information from a removable recording medium 74. The acquisition information indicates hat information is to be obtained from an information server (not shown) which manages the information, and the acquisition information of this sixth embodiment includes an information identifier to identify information, and a frequency associated with the information identifier. The frequency is a value indicating the number of times the user can obtain the information.

The acquisition information reader 71 reads the acquisition information, and when the frequency corresponding to the information identifier included in the acquisition information is 1 or more, the information acquisition unit 72 obtains the information identified by the information identifier from the information server (not shown) through a communication line. Thereafter, the information acquisition unit 72 outputs the information identifier corresponding to the obtained information to the frequency decrement unit 73.

The frequency decrement unit 73 decrements the frequency corresponding to the information identifier supplied from the information acquisition unit 72, among the frequencies recorded on the recording medium 74.

Next, the operation of the information acquisition apparatus 70 and the information acquisition method will be described.

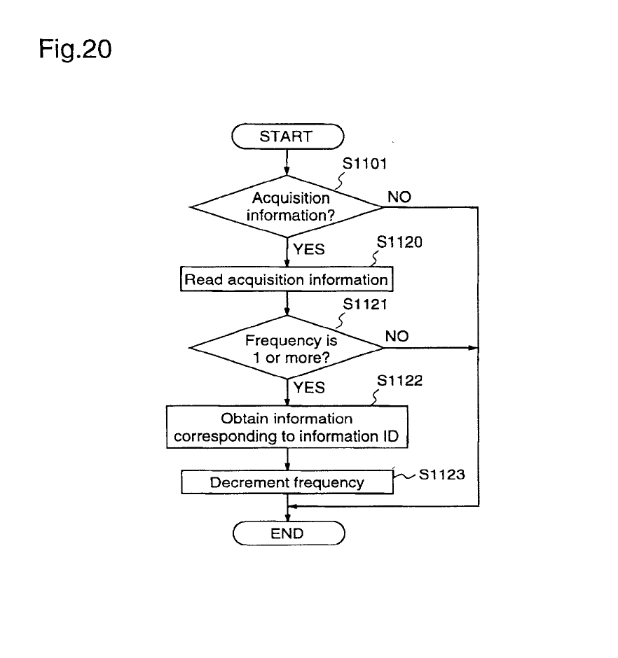

FIG. 20 is a flowchart for explaining the operation of the information acquisition apparatus 70 after the removable recording medium 74 is mounted on the apparatus 70. The process in step S1101 is identical to that in the flowchart of the fifth embodiment shown in FIG. 16 except that the acquisition information reader 61, the information acquisition unit 62, and the recording medium 63 according to the fifth embodiment are replaced with the acquisition information reader 71, the information acquisition unit 72, and the recording medium 73, respectively.

In step S1120, the acquisition information reader 71 reads the acquisition information including an information identifier and the corresponding frequency from the recording medium 74, and outputs the read acquisition information to the information acquisition unit 62.

In step S1121, the information acquisition unit 72 checks whether or not the frequency included in the inputted acquisition information is 1 or more. When the frequency is 1 or more, the information acquisition unit 72 proceeds to step S1122. Otherwise, the operation is ended.

In step S1122, the information acquisition unit 72 obtains information corresponding to the information identifier which is included in the acquisition information supplied from the acquisition information reader 71, from the information server not shown), and outputs the information identifier corresponding to the obtained information to the frequency decrement unit 73.

In step S1123, the frequency decrement unit 73 decrements the frequency corresponding to the information identifier supplied from the information acquisition unit 72, among the frequencies included in the acquisition information recorded on the recording medium 74.

Next, the operation of the information acquisition apparatus 70 will be described using a concrete example.

The following example will be described with respect to the case where the user having the recording medium 74 on which he acquisition information is recorded, obtains information from the information server.

Initially, it is assumed that the user mounts the recording medium 74, on which the acquisition information including an information identifier is recorded, on the information acquisition apparatus 70 placed at a corner of a convenience store.

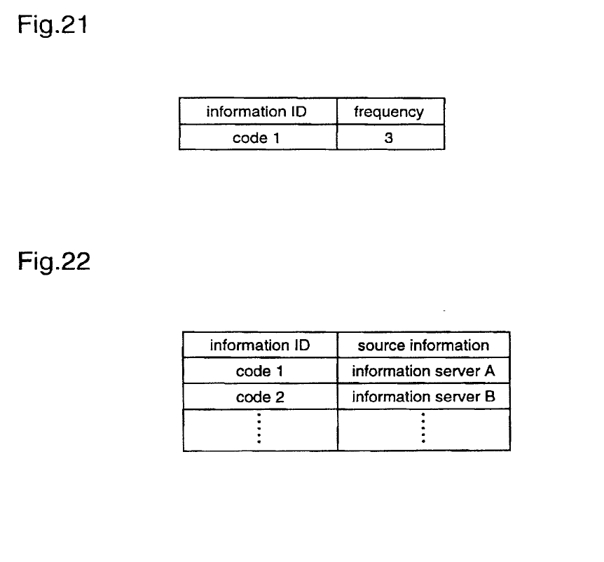

FIG. 21 is a diagram illustrating an example of acquisition information recorded on the recording medium 74.

With reference to FIG. 21, on the recording medium 74 possessed by the user, an information identifier “code 1” is recorded as an information identifier included in the acquisition information, and a frequency “3” is recorded in association with the information identifier “code 1”.

Then, the acquisition information reader 71 of the information acquisition apparatus 70 decides that the acquisition information is recorded on the recording medium (step S1101), reads the acquisition information, and outputs the acquisition information including the information identifier “code 1” and the frequency “3” to the information acquisition unit 72 (step S1120).

Since the frequency is “3”, the information acquisition unit 72 decides that the frequency is larger than “1” (step S1120). Assuming that the information server (not shown), has the information shown in FIG. 18(a), the information acquisition unit 72 obtains the music data “music 1” from the information server by transmitting, to the information server, the information identifier “code 1” supplied from the acquisition information reader 71, and then records the obtained music data on the recording medium 74 by using a recorder (not shown).

Further, the information acquisition unit 72 outputs the information identifier “code 1” corresponding to the obtained music data to the frequency decrement unit 73 (step S1122). The frequency decrement unit 73 decrements the frequency corresponding to the information identifier “code 1” held by the recording medium 74, whereby the frequency corresponding to the information identifier “code 1” becomes “2”.

In this way, the user, who has mounted the recording medium 74 containing the acquisition information on the information acquisition apparatus 70, can obtain the music data recorded on the recording medium 74, and the user can listen to the music by mounting the recording medium 74 on a player. Further, since the frequency corresponding to the information identifier “code 1” recorded on the recording medium is “2”, the user can obtain the music data further two times. For example, the case where the contents or the music data that is available by the information identifier “code 1” are changed every month, if the user obtains the music data every time the contents of the music data are changed, the user having the recording medium 74 can obtain new music data further two times.

As described above, in the information acquisition apparatus 70 and the information acquisition method according to the sixth embodiment, since the user obtains information by using the recording medium 74 on which the acquisition information having an information identifier and a frequency is recorded, the possessor (user) of the recording medium 74 can obtain the information corresponding to the information identifier associated with the frequency, by the number of times indicated by the frequency.

While in this sixth embodiment acquisition information including a single information identifier and the corresponding frequency is recorded on the recording medium 74 as shown in FIG. 21, this is merely an example, and acquisition information including plural information identifiers and the corresponding frequencies may be recorded on the recording medium 74. In this case, the user may select one or some of the recorded information identifiers to obtain only one or plural pieces of information corresponding to the selected identifier/identifiers, from the information server.

Further, while in this sixth embodiment the recording medium 74, on which an information identifier and the corresponding frequency are recorded, is employed, a recording medium, on which the acquisition information as described for the fourth embodiment includes a frequency, may be employed to obtain information corresponding to the acquisition information by the number of times indicated by the frequency.

Furthermore, when the information corresponding to the information identifier used for the fifth or sixth embodiment is music, the information identifier may be composed of a eight-digit number, and the first four digits designate the name of the singer of the music while the subsequent four digits designate the title of the music.

Hereinafter, a brief description will be given of the process of recording the acquisition information on the recording medium 53, 63, or 74 according to the fourth, fifth, or sixth embodiment, respectively.

As described for the first to third embodiment, it is assumed that the possessor (user) of the recording medium 53, 63, or 74 receives a program such as a CM of a fast-food company, with a receiver that receives broadcast. Then, the user mounts the recording medium 53, 63, or 74 on the receiver, and presses a recording button of a remote controller to record that the user has viewed the program, on the recording medium 53, 63, or 74. The information thus recorded is acquisition information. Then, the user takes the recording medium 53, 63, or 74 out of the receiver, and mounts it on the information acquisition apparatus 50, 60, or 70, whereby the user can obtain information provided by the fast-food company, from the information server. The above-mentioned process of recording the acquisition information on the recording medium 53, 63, or 74 is merely an example, and other methods than mentioned above may be used to record the acquisition information on the recording medium.

Further, while in this sixth embodiment the acquisition Information includes the frequency, this frequency may correspond to the number of viewing times indicating the number of times the user has viewed a specific program, e.g., a CM of a fast-food company. For example, the number of viewing times is recorded on the recording medium 53, 63, or 74, and the information acquisition unit 72 converts the number of viewing times “10” to the frequency “1”, and checks whether or not the frequency recorded on the recording medium is 1 or more. Further, when the frequency decrement unit 73 decrements the frequency recorded on the recording medium, it may decrements the number of viewing times by 10, instead of decrementing the frequency by 1. Moreover, the converted frequency may be recorded in association with the number of viewing times recorded on the recording medium 53, 63, or 74. For example, assuming that the number of viewing times “10” corresponds to the frequency “1”, when the number of viewing times “34” is recorded on the recording medium 53, 63, or 74, the frequency “3” is recorded in association with the number of viewing times “34”.

Further, as described for the fourth, fifth, or sixth embodiment, the user may obtain the recording medium 53, 63, or 74 on which the acquisition information is recorded(, by mounting the recording medium 53, 63, or 74 containing no acquisition information on the receiver to record the acquisition information on the medium by viewing a program. Alternatively, the user may purchase a recording medium on which desired acquisition Information is recorded, or the user may record desired acquisition information on his/her recording medium through predetermined equipment or network by paying a predetermined amount of money for it. For example, when the user purchases acquisition information by which the user can get a movie as information, the user can view the movie in a train by mounting a recording medium on which the acquisition information is recorded on an information acquisition apparatus placed in the train. Further, the user can view the movie in a hotel room by mounting the recording medium on an information acquisition apparatus placed in the hotel room.

The method of recording acquisition information on the recording medium 53, 63, and 74 is not restricted to those mentioned above. That is, when the user is viewing a program or the like on the receiver, the user mounts the recording medium 53, 63, or 74 on the receiver and then presses the recording button of the remote controller to record viewing information relating to the program on the recording medium 53, 63 or 74. For example, assuming that the user, who is viewing a music program, mounts the recording medium 53, 63, or 74 on the receiver and presses the recording button of the remote controller, viewing information relating to the music played in the program is recorded on the recording medium 53, 63, or 74. When the user mounts the recording medium 53, 63, or 74 on the information acquisition apparatus 50, 60, or 70 placed in a convenience store or the like, the user can obtain the music played in the music program. In this case, it doesn't matter whether the user obtains the music as information at cost or at no cost.

Further, the acquisition information recorded on the recording medium 53, 63, or 74 according to the fourth, fifth, or sixth embodiment may be encrypted. In this case, the acquisition information reader 51, 61, or 71 should be able to read the acquisition information by decrypting it. To encrypt the acquisition information prevents the acquisition information recorded on the recording medium 53, 63, or 74 from being rewritten.

The recording media 53, 63, and 74 are, for example, non-volatile memories such as flash memories, floppy disks, magnetic disks, optical disks, magneto-optical disks, DVD-RAMs, etc.

While in the fourth to sixth embodiments a single information server is described, a plurality of information servers may be employed. In this case, the acquisition information further includes source (server) information corresponding to each information identifier or the like.

FIG. 22 is a diagram illustrating an example of a recording medium on which source information is recorded.

With reference to FIG. 22, the names of information servers as source information are recorded In association with information identifiers on the recording medium. The user specifies information servers having desired information with reverence to the source information, whereby the user can obtain plural pieces of information from the specified information servers. In this way, the possessor (user) of the recording medium can obtain broader information from plural information servers. As the source information, an URL or the like may be used besides the name of information server shown in FIG. 22.

Further, in the fourth to sixth embodiment, the information server is located in a place distant from the information acquisition apparatus 50, 60, or 70, and the information server is connected to the information acquisition apparatus 50, 60, or 70 by the communication line. However, this is merely an example, and an information server may be contained in or placed in the vicinity of the information acquisition apparatus 50, 60, or 70. Further, even when the information server is connected to the information acquisition apparatus 50, 60, or 70 through the communication line, information that is recorded frequently may be stored in an information storage (not shown) included in the information acquisition apparatus 50, 60, or 70 so that it can be recorded on the recording medium through no communication line.

While in the concrete examples of the fourth to sixth embodiments the information acquisition apparatus 50, 60, or 70 is placed at a corner of a convenience store, this is merely an example, and the information acquisition apparatus 50, 60, or 70 may be placed at home, company, or the like, or it may be set in some place that is utilized by many and unspecified persons.

Furthermore, the information obtained from the information server by the information acquisition unit 52, 62, or 72 may be recorded on the recording medium 53, 63, or 74 as described above. When the information acquisition apparatus 50, 60, or 70 is provided with a monitor or a speaker, the user can listen to or view the information (music or video) with the information acquisition apparatus 50, 60, or 70. Further, the user may mount a recording medium other than the recording medium 53, 63, or 74 on the information acquisition apparatus 50, 60, or 70 to record the information on the inserted recording medium. Furthermore, the information recorded on the recording medium 53, 63, or 74 or the recording medium other than these media may be subjected to copy guard which permits the user to copy the information on another recording medium by one time or predetermined plural number of times, or copy guard which inhibits the user to copy the information on another recording medium.

Further, the information obtained by the information acquisition apparatus 50, 60, or 70 according to the fourth, fifth, or sixth embodiment is not restricted to video and music as described for the above embodiments, the information acquisition apparatus can obtain any information so long as it is information as data.

Further, the constituents of the receivers 10 and 40 and the viewing information processor 30 according to the first to third embodiments or the constituents of the information acquisition apparatuses 50, 60, and 70 according to the fourth to sixth embodiment may be implemented by either program-controlled software or hardware.

Moreover, a recording medium containing a program to implement any of the above-mentioned methods (i.e., the viewing information recording methods and the service contents decision methods according to the first to third embodiment or the information acquisition methods according to the fourth to sixth embodiments) may be supplied a system or equipment, and a main processor such as a CPU of the system or equipment may read and execute the program recorded on the recording medium. Also in this case, the same effects as described for the respective embodiments of the invention can be achieved.

The recording medium on which the program is recorded is, for example, a floppy disk, a hard disk, an optical disk, a magnetic disk, a magneto-optical disk, a CD-ROM, a DVD-RAM, a magnetic tape, a punch card, a non-volatile memory card, a ROM, or the like.

[Embodiment 7]

Hereinafter, a transmitter/receiver system according to a seventh embodiment of the present invention will be described with reference to the drawings.

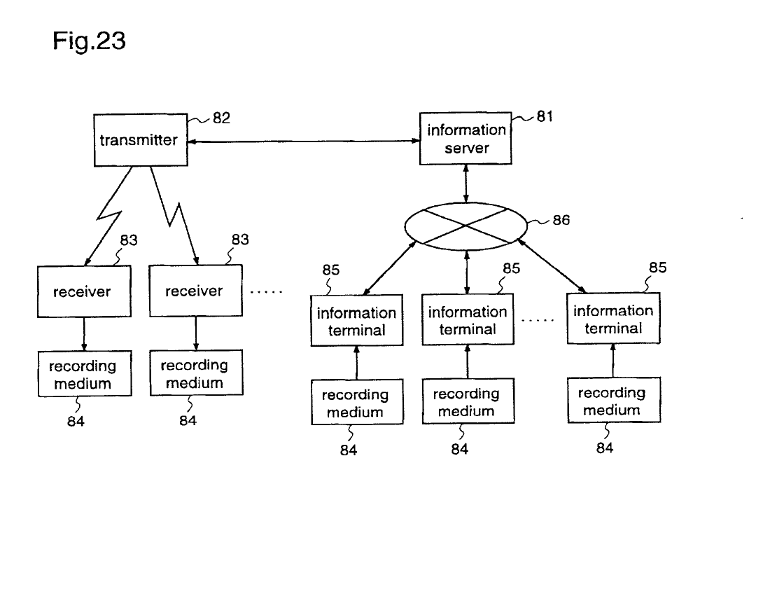

FIG. 23 is a block diagram illustrating the construction of a transmitter/receiver system according to the seventh embodiment.

With reference to FIG. 23, the transmitter/receiver system comprises an information server 81, a transmitter 82, a plurality of receivers 83, and a plurality of information terminals 85.

The information server 81 receives the correspondences between program contents and identifiers possessed by the transmitter 82 from the transmitter 82, and receives information corresponding to the respective program contents from the providers of the program contents, and holds the information in association with the identifiers corresponding to the program contents. On receipt of an identifier from any of the information terminals 85, the information server 81 transmits the information corresponding to the identifier to the information terminal 85.

The transmitter 82 holds the program contents and identifiers corresponding to the program contents. When the transmitter 82 transmits the program contents over broadcast waves to the receiver 83, it also transmits the corresponding program identifiers. Further, the transmitter 82 transmits the correspondences between the program contents and the identifiers to the information server 81.

The receiver 83 receives the program contents and the corresponding identifiers from the broadcast waves transmitted from the transmitter 82. When the user has viewed any of the program contents, the receiver 83 records the corresponding program identifier on a removable recording medium 84. This receiver 83 is identical to those described for the, first to third embodiments and, therefore, does not require repeated description.

The information terminal 85 receives the identifier from the removable recording medium 84 on which the identifier is recorded by the receiver 83, and transmits the identifier to the information server 81 through a communication network 86, whereby the information terminal 85 receives the information corresponding to the identifier. The information terminal 85 is identical to the information acquisition apparatus described for the fifth or sixth embodiment and, therefore, does not require repeated description.

The communication network 86 is a network using a communication line such as an optical fiber or a telephone line.

Next, the operation of the transmitter/receiver-system will be described.

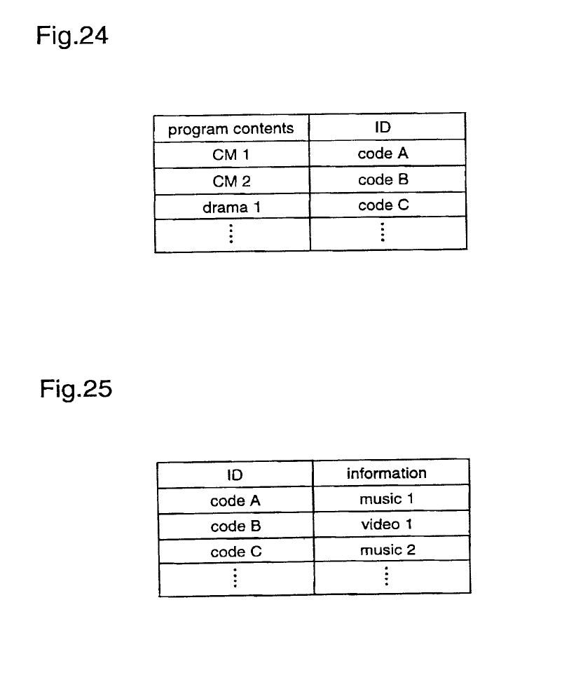

FIG. 24 is a diagram illustrating the correspondences between program contents and program identifiers, which are possessed by the transmitter 82.

The transmitter 82 transmits the correspondences between the program contents and the identifiers shown in FIG. 24 to the information server 81. The information server 81 associates the information received from the provider of the program contents with the corresponding identifier, on the basis of the correspondences between the program contents and the identifiers received from the transmitter 82. For example, when the information server 81 receives “music 1” as information from the provider of program contents “CM1”, the information server 81 holds the “music 1” in association with the identifier “code A” corresponding to the program contents “CM1” as shown in FIG. 25 with reference to the correspondences received from the transmitter 82.

It is now assumed that the transmitter 82 transmits the “CM1” as the program contents and the corresponding identifier “code A” over the broadcast waves. Then, the receiver 83 receives the program contents and the identifier, and records the identifier on the recording medium 84 as described for the first or third embodiment.

When the user mounts the removable recording medium 84 on which the identifier is recorded, on the information terminal 85, the information terminal 85 reads the recorded identifier from the recording medium 84, and transmits the identifier to the information server 81 to obtain the information corresponding to the identifier from the information server 81.

While in this seventh embodiment the transmitter 82 transmits the program contents and the corresponding identifiers over broadcast waves, the transmitter 82 may transmit the program contents and the identifiers by streaming distribution (Internet broadcast) through network to the receiver 83.

While this seventh embodiment is described for the case where the information terminal 85 is the information acquisition apparatus according to the fifth or sixth embodiment, the information terminal 85 may be identical to the viewing information processor described for the second embodiment. In this case, the transmitter/receiver system needn't have the information server 81, or the information server 81 may manage the service information stored in the viewing information processor.

As described above, the transmitter/receiver system according to the seventh embodiment is provided with the transmitter 82 for transmitting program contents and an identifier corresponding to the program contents, the receiver 83 for receiving the transmitted program contents and identifier, and recording the identifier on the removable recording medium 84, and the information terminal 85 for reading the identifier from the recording medium 84, and performing a process corresponding to the identifier. Therefore, the user having the recording medium 84 can be provided with information from the information server 81 or a service, through the information terminal 85, by viewing the program contents.

According to the receiver and the viewing information recording method of the present invention, the viewing information indicating that the user has viewed the program can be recorded on the removable recording medium by the viewing information recorder for recording the program identifier to identify the program contents. Further, when the receiver is provided with the display attribute acquisition unit, the display attribute concerning the display form by which the user has viewed the program can also be recorded on the removable recording medium. Moreover, when the number of viewing times is recorded in association with the program identifier on the recording medium, the number of times the user has viewed a specific program can be recorded on the removable recording medium, whereby the user can receive services corresponding to the number of viewing times.

Further, since the recording medium according to the present invention is removable, the user can bring the recording medium on which the viewing information is recorded to an arbitrary place, and the recording medium proves that the user has viewed a specific program.

Further, according to the viewing information processor and the service contents decision method of the present invention, since the viewing information is read from the recording medium and then the service contents corresponding to the viewing information is output, it is possible to provide the user who has viewed a specific program, with a service based on that the user has viewed the program.

Furthermore, according to the information acquisition apparatus and the information acquisition method of the present invention, since the acquisition information is read from the recording medium and then the information is obtained from the information server, the user can obtain the information without paying a predetermined amount of money. Further, since the information is supplied from the information server that is connected to the information acquisition apparatus through a communication line, the user can get the latest information.

Furthermore, since the information is obtained by using the recording medium on which the acquisition information including the information identifier is recorded, the user, i.e., the possessor of the recording medium, can obtain the information corresponding to the information identifier.

Furthermore, since the information is obtained by using the recording medium on which the acquisition information including the information identifier and the frequency is recorded, the user, i.e., the possessor of the recording medium, can obtain the information corresponding to the information identifier associated with the frequency, by the number of times indicated by the frequency.

Furthermore, according to the recording medium of the present invention, since the acquisition information indicating the condition to obtain information is recorded on the recording medium, the user can obtain the information by only the acquisition information, without paying a predetermined amount of money.

Furthermore, the transmitter/receiver system of the present invention is provided with the transmitter for transmitting program contents and the corresponding identifier, the receiver for receiving the transmitted program contents and identifier and recording the identifier on the removable recording medium, and the information terminal for reading the identifier recorded on the removable recording medium and performing a process corresponding to the identifier. Therefore, the user having the recording medium can be provided with information from the information terminal or a service, by viewing the program contents.

Moreover, according to the present invention, since a predetermined identifier corresponding to information such as video data or music data is recorded on a recording medium, even though the information itself is not recorded on the recording medium, the user can easily obtain the information at a station stall or a convenience store. Therefore, the user needn't record the information on the recording medium to carry, and the quantity of data to be recorded on the recording medium is reduced.

What is claimed is:

1. A receiver comprising:
a program acceptor for accepting program contents, and program information having a program identifier to identify program contents;
a display unit for displaying the program contents; and
a viewing information recorder for recording viewing information having the program identifier to identity the program contents on a removable recording medium, when the program contents are displayed on the display unit.

2. The receiver of claim 1 further comprising:
a display attribute acquisition unit for obtaining a display attribute that is an attribute by which the program contents are displayed;
wherein the viewing information has the display attribute and the program identifier.

3. The receiver of claim 2, wherein the display attribute is the position where the program contents are displayed.

4. The receiver of claim 1, wherein the viewing information further includes the number of viewing times, which is the number of times a user has viewed the program contents.

5. The receiver of claim 1 further comprising:
an input acceptor for accepting a user input;
wherein, when the program contents are displayed on the display unit on the basis of the user input accepted by the input acceptor, the viewing information recorder records the viewing information on the removable recording medium.

6. The receiver of claim 5 wherein, when the input acceptor accepts the user input for a predetermined period of time, the viewing information recorder records the viewing information on the removable recording medium.

7. The receiver of claim 5, wherein:
the input acceptor accepts an input of information related to the program; and
when the input acceptor accepts the related information, the viewing information recorder records the viewing information on the removable recording medium.

8. A viewing information recording method comprising:
a program accepting step of accepting program contents, and program information having a program identifier to identify program contents;
a display step of displaying the program contents; and
a viewing information recording step of recording viewing information having the program identifier to identify the program contents on a removable recording medium, when the program contents are displayed on the display unit.

9. The viewing information recording method of claim 8 further comprising:
a display attribute acquisition step of obtaining a display attribute that is an attribute by which the program contents are displayed;
wherein the viewing information has the display attribute and the program identifier.

10. The viewing information recording method of claim 9, wherein the display attribute is the position where the program contents are displayed.

11. The viewing information recording method or claim 8, wherein the viewing information further includes the number of viewing times, which is the number of times a user has viewed the program contents.

12. The viewing information recording method of claim 8 further comprising:
an input accepting step of accepting a user input;
wherein, when the program contents are displayed on the display unit on the basis of the user input accepted in the input accepting step, the viewing information is recorded on the removable recording medium in the viewing information recording step.

13. The viewing information recording method of claim 12 wherein, when the user input is accepted for a predetermined period of time in the input accepting step, the viewing information is recorded on the removable recording medium in the viewing information recording step.

14. The viewing information recording method of claim 12, wherein:
an input of information related to the program is accepted in the input accepting step; and
when the related information is inputted in the input accepting step, the viewing information is recorded on the removable recording medium in the viewing information recording step.

15. A computer-readable program recording medium on which a program to make a computer execute the following process steps is recorded:
a program accepting step of accepting program contents, and program information having a program identifies to identify program contents;
a display step of displaying the program contents; and
a viewing information recording step of recording viewing information having the program identifier to identify the program contents on a removable recording medium, when the program contents are displayed on the display unit.

16. A removable recording medium on which viewing information is recorded by the viewing information recording method of claim 8.

17. A service contents decision method for deciding service contents on the basis of viewing information recorded on a removable recording medium.

18. A viewing information processor for reading viewing information recorded on a removable recording medium, and processing the viewing information, comprising:
a viewing information acquisition unit for reading the viewing information;
a service information holding unit for holding service contents in association with a provision condition that is a condition to provide a service specified by the service contents;
a service contents decision unit for deciding the service contents, by applying the provision condition held by the service information holding unit to the viewing information obtained by the viewing information acquisition unit; and
a service contents output unit for outputting the service contents decided by the service contents decision unit.

19. The viewing information processor of claim 18 further comprising a viewing information deletion unit for deleting the viewing information recorded on the recording medium, when the service contents output unit outputs the service contents.

20. An information acquisition apparatus for obtaining information from an information server which manages the information, comprising:
an acquisition information reader for reading acquisition information, which indicates that information is to be obtained, from a removable recording media on which the acquisition information is recorded; and
an information acquisition unit for obtaining the information from the information server when the acquisition information reader obtains the acquisition information.

21. An information acquisition apparatus for obtaining information from an information server which manages the information in association with an information identifier to identify the information, comprising:
an acquisition information reader for reading acquisition information having an information identifier, from a removable recording media on which the acquisition information is recorded; and
an information acquisition unit for obtaining, from the information server, the information identified by the information identifier included in the acquisition information.

22. The information acquisition apparatus of claim 21, wherein:
the acquisition information also includes a frequency indicating the number of times a user can obtain the information;
the apparatus further comprises a frequency decrement unit for decrementing the frequency when the information acquisition unit obtains the information; and
when the frequency is 1 or more, the information acquisition unit obtains the information.

23. An information acquisition method for obtaining information from an information server which manages the information, comprising:
an acquisition information reading step of reading acquisition information, which indicates that information is to be obtained, from a removable recording media on which the acquisition information is recorded; and
an information acquisition step of obtaining the information from the information server when the acquisition information is obtained in the acquisition information reading step.

24. An information acquisition method for obtaining information from an information server which manages the information in association with an information identifier to identify the information, comprising:
an acquisition information reading step of reading acquisition information having an information identifier, from a removable recording media on which the acquisition information is recorded; and
an information acquisition step of obtaining, from the information server, the information identified by the information identifier included in the acquisition information.

25. The information acquisition method of claim 24, wherein:
the acquisition information also includes a frequency indicating the number of times a user can obtain the information in the information acquisition step;
the method further comprises a frequency decrement step of decrementing the frequency when the information is obtained in the information acquisition step; and
when the frequency is 1 or more, the information is obtained in the information acquisition step.

26. A computer-readable program recording medium on which a program for obtaining information from an information server that manages the information is recorded, said program making a computer execute the following process steps:
an acquisition information reading step of reading acquisition information, which indicates that information is to be obtained, from a removable recording media on which the acquisition information is recorded; and
an information acquisition step of obtaining the information from the information server when the acquisition information is obtained in the acquisition information reading step.

27. A recording medium to be mounted on the information acquisition apparatus of claim 20.

28. A recording medium having an information identifier and a frequency.

29. A transmitter/receiver system comprising:
a transmitter for transmitting program contents and a right identifier corresponding to the program contents;
a receiver for receiving the program contents and a right identifier transmitted from the transmitter, and recording the right identifier on a removable recording medium; and
an information terminal for reading the right identifier recorded on the removable recording medium, and performing a process corresponding to the right identifier;
wherein said receiver comprises:
a program acceptor for accepting the program contents and the right identifier;
a display unit for displaying the program contents; and
a viewing information recorder for recording the right identifier corresponding to the program contents on the removable recording medium, when the program contents are displayed on the display unit.

30. The transmitter/receiver system of claim 29, wherein the transmitter transmits the program contents and the right identifier on broadcast waves.

31. The transmitter/receiver system of claim 23, wherein the transmitter transmits the program contents and the right identifier through a communication network.

32. The transmitter/receiver system of claim 29, wherein the information terminal comprises:
an identifier acquisition unit for reading the right identifier recorded on the removable recording medium;
a service information holding unit for holding service contents in association with a provision condition that is a condition to provide a service decided by the service contents;
a service contents decision unit for deciding the service contents, by applying the provision condition held by the service information holding unit to the right identifier obtained by the identifier acquisition unit; and
a service contents output unit for outputting the service contents decided by the service contents decision unit.

33. The transmitter/receiver system of claim 29 further comprising:
an information server which holds information in association with the right identifier transmitted from the transmitter and, on receipt of the right identifier from the information terminal, transmits the information corresponding to the right identifier to the information terminal;
wherein said information terminal transmits the right identifier read from the removable recording medium to the information server, and receives the information corresponding to the transmitted right identifier from the information server.

34. the transmitter/receiver system of claim 33, wherein the information terminal comprises:
an identifier reader for reading a right identifier from a removable recording medium on which the right identifier is recorded; and
an information acquisition unit for transmitting the right identifier to the information server when the identifier reader reads the right identifier to obtain information from the information server.
